(19) United States
(12) Patent Application Publication
(10) Pub. No.: US 2012/0167327 A1
(43) Pub. Date: Jul. 5, 2012

(54) CONNECTING DEVICE FOR A WINDSHIELD WIPER SYSTEM

(76) Inventors: Daniel Kasack, Oberkotzau (DE); Peter Zielke, Adorf (DE); Markus Rathey, Bad Bellingen (DE); Joachim Domröse, Eisenach (DE)

(21) Appl. No.: 13/394,553

(22) PCT Filed: Sep. 14, 2010
(86) PCT No.: PCT/EP2010/005622

§ 371 Date: Mar. 7, 2012

(30) Foreign Application Priority Data
Sep. 15, 2009 (DE) 20 2009 012 431.2

(51) Int. Cl. B60S 1/40; B60S 1/48

(52) U.S. Cl. 15/250.04

(57) ABSTRACT

The invention relates to a connecting device (10) for a windshield wiper system, comprising an integral housing (12) made of a plastic material, wherein the housing (12) has at least one inflow connection (14, 16) for the inflow of fluid, and at least one outflow connection (19) for the outflow of the fluid, wherein the inflow connection (14, 16) is connected in a fluid-conducting manner to the outflow connection (19) via at least one fluid line (22) formed in the housing (12). The connecting device (10) further comprises at least one valve (28) for separating the fluid-conducting connection, at least one electric heating means (32), which is provided for warming up the fluid line (22) and the valve (28), at least one power source power supply (38), and at least one consumer power supply (40), wherein the power source power supply (38) can be connected to a power source, and the consumer power supply (40) can be connected to an electrical consumer. The electrical heating means (32) can be supplied with energy by way of the power source power supply (38), and a consumer can be supplied with energy by way of the consumer power supply.

### BACKGROUND OF THE INVENTION

The present invention relates to a connecting device for a windshield wiper system, having a one-piece housing made of plastic material, the housing having at least one inlet connection for inflow of fluid and at least one outlet connection for the outflow of fluid, and the inlet connection being connected in a fluid-conducting manner to the outlet connection via at least one fluid line provided in the housing.

Known connecting devices for windshield wiper systems, which are provided for establishing a fluid-conducting connection between the connection partners via inflow and outflow of a fluid, are used, for example, also in modern, i.e., recent model windshield wiper systems for motor vehicles, in which a windshield washer fluid is sprayed from nozzles on the wiper blades, the nozzles being located in close proximity to the wiper lip so that when a windshield cleaning operation is initiated, a jet of cleaning fluid which interferes with the field of vision is not produced, since this jet is concealed by the wiper blade or the wiper arm. However, the technical implementation of these types of windshield wiper systems requires a large amount of space for installation, and the known connecting devices that are used are provided only for establishing a fluid-conducting connection between a reservoir for holding the cleaning fluid and the nozzles of the wiper blades. A pump for the windshield wiper system is provided to convey the cleaning fluid from the reservoir directly through the connecting device to the wiper blades, and lastly, to the nozzles.

### OBJECT OF THE INVENTION

The object of the present invention is to provide a connecting device which allows the installation space for installing a windshield wiper system of a motor vehicle to be greatly reduced compared to known approaches.

### ACHIEVEMENT OF THE OBJECT OF THE INVENTION

This object is achieved according to the invention using a connecting device for a windshield wiper system which has a one-piece housing made of plastic material, the housing having at least one inlet connection for inflow of fluid and at least one outlet connection for the outflow of the fluid, the inlet connection being connected in a fluid-conducting manner to the outlet connection via at least one fluid line provided in the housing, and the connecting device also having at least one valve for interrupting the fluid-conducting connection, at least one electric heating means which is provided for heating the fluid line and the valve, at least one power source power connection, and at least one consuming power connection, the power source power connection being connectable to a power source, and the consuming power connection being connectable to an electrical consumer, the electric heating means being supplied with power from the power source which is connected to the power source power connection, and the consumer which is connected to the consuming power connection being supplied with power from the power source which is connected to the power source power connection.

The valve provided according to the invention for interrupting the fluid-conducting connection, which preferably may be at least partially or completely accommodated in an inner space, indentation, or recess in the housing, and which is provided for interrupting the fluid-conducting connection, i.e., for closing the fluid line, allows a space-saving implementation of a valve-operated fluid control system in such a way that no additional room, i.e., installation space, must be provided for the valve in the vicinity of the connecting device, and at the same time the installation space required for installing the windshield wiper system on a motor vehicle is reduced. In particular, the valve may be used to control the flow of a cleaning fluid, which in modern windshield wiper systems for motor vehicles may be conveyed from a reservoir, directly through the connecting device to the wiper blades, and lastly, to the nozzles. The nozzles are located in close proximity to the wiper lip so that when a windshield cleaning operation is initiated, a jet of cleaning fluid which interferes with the field of vision is not produced, since this jet is concealed by the wiper blade or the wiper arm.

The electric heating means provided according to the invention is provided for heating the fluid line and optionally also for thawing (if the fluid line is at least partially frozen due to low temperatures or outside temperatures), and may also be provided in particular for heating a partial area of the housing in which the fluid line is provided, preferably for heating the entire housing. The heating means is also provided for heating or thawing the valve (if the valve is at least partially frozen due to low temperatures or outside temperatures).

The heating means is used in particular to prevent the fluid line and the valve from freezing up at low outside temperatures below the freezing point when fluid, for example water or cleaning fluid, i.e., windshield washer fluid, flows through the fluid line. The electric heating means may also be used to appropriately heat fluid flowing through the connecting device in order to prevent components situated downstream from the connecting device, for example nozzles from which a fluid in the form of a windshield washer fluid is emitted in the form of a jet, from freezing up. A space-saving implementation of fluid heating or component heating of a windshield wiper system is also possible using the electric heating means of the connecting device according to the invention, the electric heating means preferably being at least partially or completely accommodated in an inner space, indentation, or recess in the housing, in such a way that no additional room, i.e., installation space, must be provided for the heating means in the vicinity of the connecting device, and at the same time the space required for installing the windshield wiper system is reduced.

The heating means may be supplied with power from a power source in a practical manner via the power source power connection provided according to the invention. This allows a simplified and very practical installation of the windshield wiper system. Thus, the heating means, in particular after the connecting device is installed, may be easily brought into an operable state by connecting the power source connection to a power source.

In addition, by means of the consuming power connection provided according to the invention, any given electrical consumer may be supplied with power from the power source which is connected to the power source power connection. In particular, in this manner the installation of the windshield wiper system is greatly simplified in such a way that, in particular after the connecting device is installed, electrical consuming devices, for example a wiper arm heating device or any other given electrical consuming devices, may be brought into an operable state.

In particular, according to the invention a plurality of consuming power connections may be provided to allow a plurality of electrical consuming devices to be brought into an operable state. To simplify the installation, it may also be advantageous to provide a plurality of power source power connections in addition to a plurality of consuming power connections. Depending on the design of the motor vehicle, for example one of the power source connections may be more easily accessible than another, so that power can be supplied only via this power source connection, and at the same time increased flexibility during installation of the windshield wiper system is provided. Accordingly, providing a plurality of consuming power connections is associated with increased flexibility during installation of the windshield wiper system.

Overall, the connecting device according to the invention allows not only a significant reduction in the installation space, i.e., the space requirements, to be provided for installing the windshield wiper system, but also greatly simplified installation of the windshield wiper system, together with a considerable reduction in the installation time, and therefore, also a considerable reduction in the installation costs. Providing the technical functions of the connecting device according to the invention using known standard components, in contrast to the connecting device according to the invention, would involve a significant increase in the installation space, poor or low heating capacity or heat output, and poor or less than optimal integration of hydraulic and electrical components.

In one practical embodiment, the connecting device has only one inlet connection and only one outlet connection, and also only one power source power connection and only one consuming power connection.

As a base variant, this practical embodiment allows transmission of fluid, flow of the fluid, which is controllable via the valve, through the connecting device, heating of the fluid or the fluid line and the valve via a heating means, and in addition to supplying power to the heating means via the power source power connection, also supplying power to an electrical consumer which is connected to the consuming power connection.

The valve is particularly preferably designed in the form of a check valve. In the open state or partially open state, a check valve allows fluid flow from the inlet connection toward the outlet connection in a manner known per se. By using a valve in the form of a check valve, a fluid that is present between the check valve and a fluid pump may be held stationary without flowing out under the effect of gravitational force, for example, in particular when the fluid pump is in an idle state in which it builds up little or no pump pressure. This has the advantage that the fluid is not able to flow out under the effect of gravitational force. During operation of the pump, which in particular may be a pump for conveying windshield washer fluid to the nozzles of a windshield wiper system, the check valve opens as the result of a sufficiently high pump pressure in order to convey the cleaning fluid to the nozzles. Since in the idle state of the fluid pump, the fluid present between the check valve and the fluid pump has been held stationary, it is possible to effectively save pumping power and pumping time, which, without the check valve for the flowthrough or filling of the fluid present between the check valve and the fluid pump, would otherwise have to be expended.

In one practical embodiment, the heating means is designed in the form of a PTC element.

Positive temperature coefficient (PTC) elements, also referred to as PTC resistors or PTC thermistors, are known temperature-dependent semiconductor resistors which are able to conduct current better at lower temperatures than at high temperatures. Their electrical resistance increases with increasing temperature, whereby PTC elements are characterized in particular in that their resistance increases greatly above a certain temperature, and in addition, a PTC element has relatively high self-heating above a certain voltage. Use is made of these properties in a known manner for measurements and in control technology. Below this voltage, the PTC element responds in the manner of a normal resistor, and responds essentially only to external heating.

As a result of the properties of the PTC element, the heating caused by the PTC element is self-regulating; i.e., at low local temperatures, due its low resistance the PTC element provides a high heat output, and thus, high heating when necessary. On the other hand, at high temperatures only slight heating occurs due to the high resistance of the PTC element which is then present. Overall, heating of the fluid line, the valve, the fluid, and the housing which is adapted to the temperature may be carried out in a practical and simple manner using the PTC element.

The PTC element particularly preferably has at least one resistor which has the shape of a circular disk, whereby a circular surface of a resistor preferably faces a section of the fluid line. For a resistor in the form of a circular disk, most of the heat energy produced by current flowing through the resistor may be dissipated by thermal radiation or thermal conduction over the circular surfaces of the circular disk, whereby heat transport by thermal conduction requires a corresponding temperature gradient. If a circular surface of the resistor preferably faces a section of the fluid line, a very large portion of the heat energy produced by current flowing through the resistor per unit time may be conducted in the direction of the section of the fluid line, at the same time providing very effective heating of this section. Similarly, very effective heating of the valve or a section of the fluid line adjoining the valve may be achieved when a circular surface of the resistor preferably faces the valve. Alternatively, however, the resistor may have the shape of a cylinder or a disk which preferably has a base area in the shape of a rectangular surface or in the shape of a surface of a polygon. In that case, the base area preferably faces the valve and/or a section of the fluid line. The resistor may also be rod-shaped, for example.

In one particularly advantageous embodiment, a material for increasing the thermal conduction between the heating means and at least one section of the fluid line is provided to allow very effective heating of the section. In particular, a material for increasing the thermal conduction between the heating means and the valve may also preferably be provided to allow very effective heating of the valve, or also for heating the valve together with a section of the fluid line adjoining the valve.

The material for increasing the thermal conduction may preferably be a resin material, which is known to have a high thermal conductivity. The resin material is particularly preferably a cast resin which advantageously may be brought into a desired shape or position by appropriate casting, and which after the casting may be integrally joined to the housing. The material for increasing the thermal conduction may in particular also be a PUR material.

In one preferred embodiment, the housing is an injection-molded part which is inexpensively manufacturable in large quantities in a known manner, using an appropriate injection molding die.

In one practical embodiment, one inlet connection and two outlet connections are provided, the valve for interrupting the fluid-conducting connection being provided between the inlet connection and each of the outlet connections. In this practical embodiment, the valve is provided for interrupting the fluid-conducting connection between the inlet connection and each of the outlet connections to be able to prevent, if necessary, fluid from flowing through the connecting device, specifically, for example after completing a windshield cleaning operation using fluid in the form of a windshield washer fluid.

In another practical embodiment, a first and a second inlet connection as well as a first pair of outlet connections and a second pair of outlet connections are provided, the first inlet connection being connected in a fluid-conducting manner to each of the outlet connections of the first pair via at least one first fluid line, and the second inlet connection being connected in a fluid-conducting manner to each of the outlet connections of the second pair via at least one second fluid line, the second fluid line being separate from the first fluid line, and a first valve for interrupting the fluid-conducting connection being provided between the first inlet connection and each of the outlet connections of the first pair, and a second valve for interrupting the fluid-conducting connection being provided between the second inlet connection and each of the outlet connections of the second pair.

In this further practical embodiment, as a result of separating the first fluid line from the second fluid line, the connecting device provides two independent, separate subsystems in particular for fluid transmission or fluid distribution, it being possible to prevent flow through each subsystem by means of the first or second valve. A power source power connection and two consuming power connections, or two power source power connections and four consuming power connections, are preferably provided in this further practical embodiment. These provided numbers of consuming power connections or power source connections allow very practical and simple installation of a great variety of windshield wiper systems by providing a sufficient number of consuming power connections and power source connections.

### BRIEF DESCRIPTION OF THE DRAWINGS

Exemplary embodiments of the invention are [explained] in greater detail below with reference to the accompanying drawings, which show the following:

FIG. 1 shows a top view of a first exemplary embodiment of the connecting device according to the invention,

FIG. 2 shows a sectional view of the first exemplary embodiment according to section A-A illustrated in FIG. 1,

FIG. 3 shows a side view of the first exemplary embodiment,

FIG. 4 shows a three-dimensional illustration of the first exemplary embodiment,

FIG. 5 shows a top view of a second exemplary embodiment of the connecting device according to the invention,

FIG. 6 shows a sectional view of the second exemplary embodiment according to section A-A illustrated in FIG. 5,

FIG. 7 shows a side view of the second exemplary embodiment,

FIG. 8 shows a three-dimensional illustration of the second exemplary embodiment,

FIG. 9 shows a schematic sectional illustration of a wiper arm of a windshield wiper system, with a wiper blade mounted thereon, and

FIG. 10 shows a schematic diagram for illustrating the use of a connecting device according to the invention in a windshield wiper system.

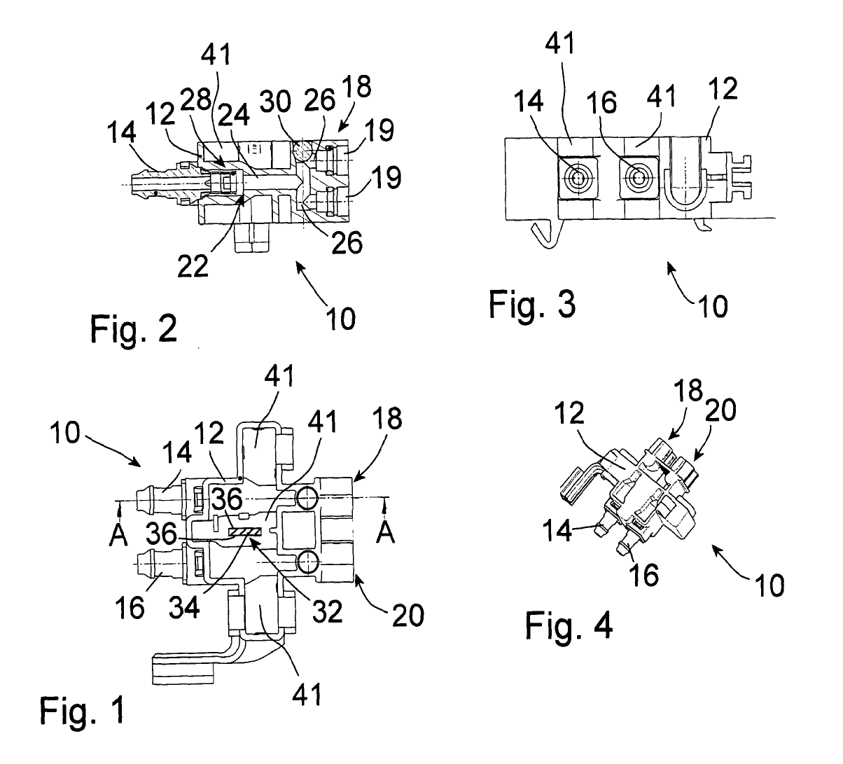

FIG. 1 shows a top view of a first exemplary embodiment of the connecting device 10 according to the invention. The illustrated connecting device 10 has a one-piece housing 12 in the form of an injection-molded part, the housing 12 having a first and a second inlet connection 14, 16 as well as a first pair 18 of outlet connections 19 and a second pair 20 of outlet connections 19. The sectional view shown in FIG. 2 illustrates the first inlet connection 14 and the first pair 18 of outlet connections 19, the inlet connections 14, 16 being designed or designable for connection to standard components.

The first inlet connection 14 is connected in a fluid-conducting manner to each of the outlet connections 19 of the first pair 18 via a first fluid line 22, the fluid line 22 having a first section 24 which extends from the first inlet connection 14, and two second sections 26 which extend from the first section 24 to each of the outlet connections 19 of the first pair 18. Similarly, the second inlet connection 16 is also connected in a fluid-conducting manner to each of the outlet connections 19 of the second pair 20 via a second fluid line having an identical design to the first fluid line 22, the second fluid line being separate from the first fluid line 22, and at the same time two separate, independent subsystems in particular for fluid transmission or fluid distribution being provided. This connecting device 10 thus has the design of a typical “2 times Y” configuration; i.e., the connecting device 10 has two separate “Y connections.”

The illustrated connecting device 10 has a first valve 28 and a structurally identical second valve which are designed in the form of a check valve 28, a sectional illustration of the first valve 28 being shown in FIG. 2. The valves 28 are provided for interrupting the fluid-conducting connection between the first and the second inlet connection 14, 16 and each of the outlet connections 19 of the first and second pairs 18, 20; i.e., in the present case the valves 28 are provided for closing the first section 24 of the first fluid line 22 and the first section of the second fluid line, respectively. A closing ball 30 is provided for the effective tight closing of a production-related opening in the housing 12.

The connecting device 10 has a heating means, schematically illustrated in FIG. 1, in the form of a PTC element 32 which has a resistor 34 in the form of a circular disk, a schematic top view of the edge of the resistor 34 being illustrated in FIG. 1. For achieving a high heat flow density in the direction of the first fluid line 22, i.e., in the direction of the first valve 28, one of the two circular surfaces 36 of the resistor 34 faces the first section 24 of the first fluid line 22, i.e., the first valve 28. Similarly, the other of the two circular surfaces 36 faces the first section of the second fluid line, i.e., the second valve.

In addition, a material 41 for increasing the thermal conduction, i.e., for achieving a high heat flow density, between the resistor 34 of the PTC element 32 and at least the first section 24 of the first fluid line 22 and at least the first section of the second fluid line is provided, the material 41 being designed in the form of a resin material which is integrally joined to the housing 12. The resin material 41 may in particular be poured into an indentation, recess, or inner space in the housing 12, or may be at least partially accommodated in an indentation, recess, or inner space in the housing 12. In particular, good thawing behavior may be achieved by heating using the PTC element 32, by means of which self-regulating heating is possible, in conjunction with the resin material 41, which in particular may be a cast resin (a 2K epoxy resin, for example). In addition, the thawing behavior or heating behavior is further improved by providing the check valve 28 in close proximity to the PTC element 32. Furthermore, the connecting device 10 according to the invention allows a compact design as well as low space requirements, and in particular also further improvement in the thawing behavior or heating behavior.

FIGS. 3 and 4 illustrate the connecting device 10 from other perspectives.

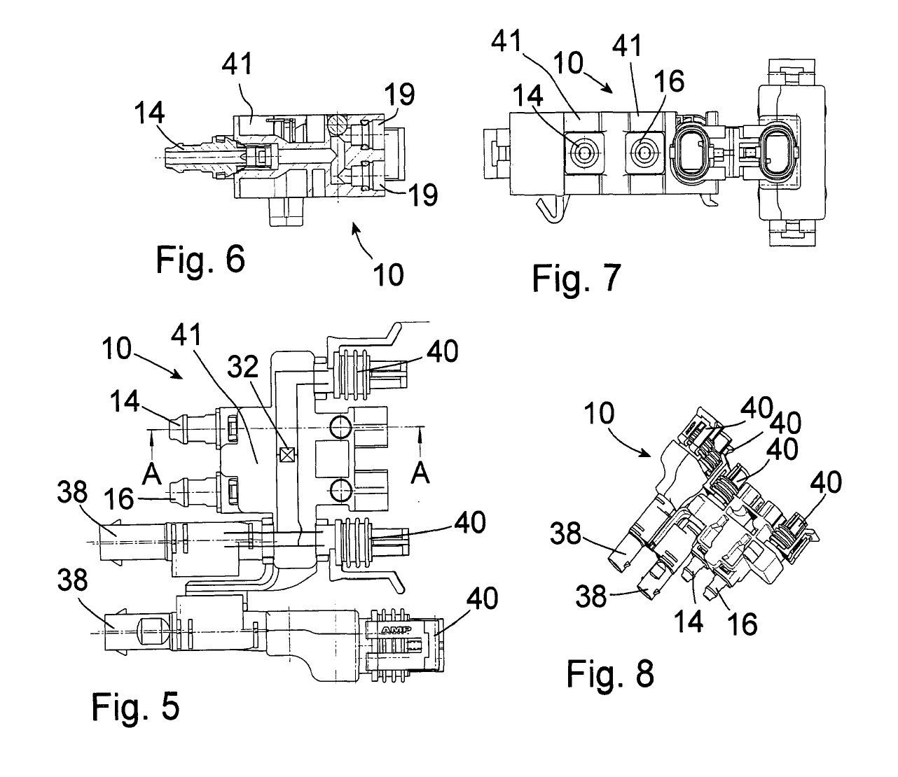

The second exemplary embodiment of the connecting device 10 according to the invention, illustrated in FIGS. 5 through 8, differs from the first exemplary embodiment in that two power source power connections 38 and four consuming power connections 40 are provided.

As schematically illustrated in the top view, shown in FIG. 5, of an upper power source power connection 38 and two upper consuming power connections 40, the two consuming power connections 40, the power source power connection 38, and the PTC element 32 (illustrated in only a schematic manner here) are connected to one another in an electrically conductive manner in the form of a parallel connection, so that the PTC element 32 is supplied with power from a power source or power sources connected to the power source power connection 38 (or the power source power connections 38), and wherein in addition one or more consuming devices which is/are connected to the consuming power connection(s) 40 is/are supplied with power from the power source or power sources connected to the power source power connection(s) 38. The power source may in particular be a vehicle power supply having a supply voltage of 13 volts to 14 volts, preferably approximately 13.2 volts.

By means of the provided power source power connections 38 and consuming power connections 40, in combination with the provided inlet connections 14, 16 and outlet connections 19, a connecting device 10 is provided which has only a very small installation space, i.e., space requirements, and which represents a central interface for an electrical system and a hydraulic system.

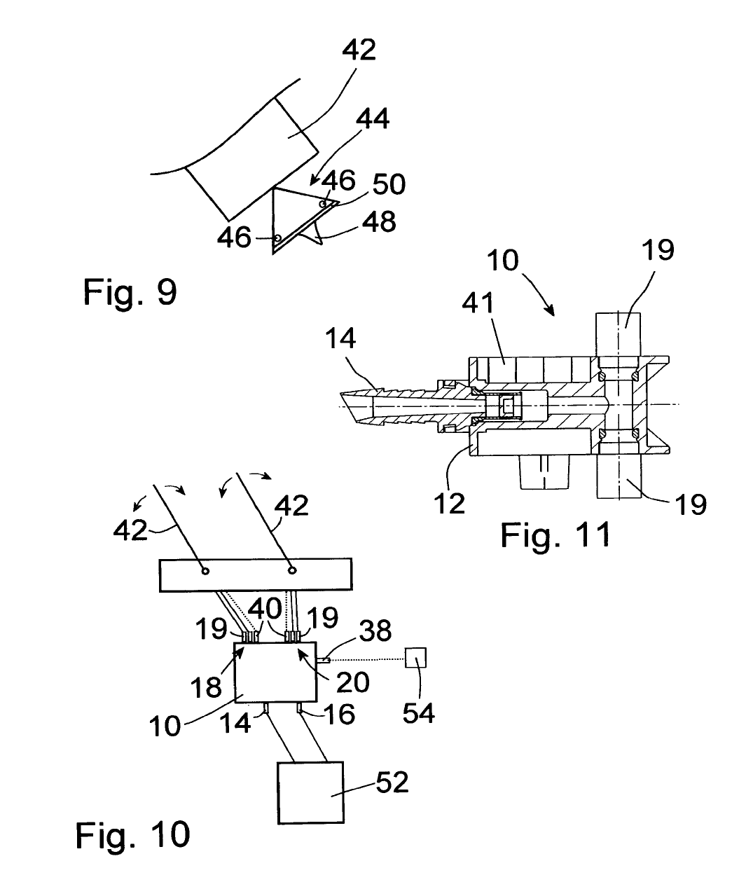

FIG. 9 shows a schematic sectional illustration of a wiper arm 42 of a windshield wiper system, with a wiper blade 44 mounted thereon. This sectional diagram illustrates the design of a wiper blade 44 as used in a modern, i.e., recent model, windshield wiper system, in which the nozzles 46 from which the windshield washer fluid (for example, water, or water in which a cleaning agent is dissolved) for cleaning the windshield of the motor vehicle is emitted are situated in close proximity to the wiper lip or sealing lip 48, so that when a windshield cleaning operation is initiated, a jet of cleaning fluid which interferes with the field of vision is not produced, since this jet is concealed by the wiper blade 44 or the wiper arm 42. The wiper blade 44 also has a schematically illustrated heating device 50 for heating the wiper blade 44 at low temperatures or outside temperatures. The heating device 50 of the wiper blade 44 represents an electrical consumer, which for supplying power may be connected via a suitable plug to a consuming power connection 40 of the connecting device 10.

FIG. 10 shows a schematic diagram for illustrating the use of a connecting device 10 according to the invention in a windshield wiper system. The schematically illustrated connecting device 10 has two inlet connections 14, 16 and two pairs 18, 20 of outlet connections 19, the inlet [sic; outlet] connections 19 having no fluid-conducting connection with one another, and the pairs 18, 20 having no fluid-conducting connection with one another.

The connecting device 10 establishes fluid-conducting connections between the nozzles 46 (see FIG. 9) of two wiper arms 42 and a reservoir 52 which holds fluid in the form of a windshield washer fluid. The nozzles 46, corresponding to FIG. 9, are in close proximity to the wiper lip (not illustrated in FIG. 10).

A fluid pump (not illustrated) which is integrated into the reservoir or situated at another location is provided for conveying the windshield washer fluid from the reservoir 52 directly through the connecting device 10 and to the nozzles 46. The windshield wiper system is provided for discharging windshield washer fluid from the nozzles 46 only at the lower and upper motion reversal points of the wiper arms 42 (indicated by the arrows in FIG. 10), the inlet connection 14 at the left in FIG. 10 being provided for conveying windshield washer fluid to the nozzles 46 when the wiper arms 42 are located at the upper motion reversal point, and the inlet connection 16 at the right in FIG. 10 being provided for conveying windshield washer fluid to the nozzles 46 when the wiper arms 42 are located at the lower motion reversal point. By means of the provided power source power connections 38 and consuming power connections 40 in combination with the provided inlet connections 14, 16 and outlet connections 19, a connecting device 10 is provided which has only a very small installation space, i.e., space requirements, and which represents a central interface for an electrical system and a hydraulic system. The heating devices 50 (not illustrated here) of the wiper blades which are mounted on the wiper arms 42 represent electrical consuming devices which for supplying power may be connected via a suitable plug and conductor (only illustrated by a dotted line here) to the consuming power connections 40 of the connecting device 10. The power source power connection 38 is in operative electrical connection with a power source 54 of the motor vehicle.

The fluid line provided for establishing a fluid-conducting connection between an inlet connection 14, 16 and a pair of outlet connections 18, 20, respectively, is closable by means of a check valve (not illustrated in FIG. 10). By using the check valve, a fluid that is present between the check valve and the fluid pump may be held stationary without flowing out under the effect of gravitational force, for example, in particular when the fluid pump is in an idle state in which it builds up little or no pump pressure. This has the advantage that the fluid is not able to flow out under the effect of gravitational force. During operation of the pump, the check valve opens as the result of a sufficiently high pump pressure in order to convey the windshield washer fluid to the nozzles 46.

FIG. 11 shows a connecting device 10 having a one-piece housing 12 in the form of an injection-molded part, the housing 12 having a first inlet connection 14 and a first pair 18 of outlet connections 19. Compared to the connecting device 10 illustrated in FIGS. 1 through 4, the outlet connections 19 lead out laterally from the connecting device 10. In this case, the use of closing balls 30 may be dispensed with in the manufacture of the housing 12.

### LIST OF REFERENCE NUMERALS

10 Connecting device
12 Housing
14 First inlet connection
16 Second inlet connection
18 First pair of outlet connections
19 Outlet connection
20 Second pair of outlet connections
22 Fluid line (first)
24 First section of fluid line
26 Second section of fluid line
28 Check valve
30 Closing ball
32 PTC element
34 Resistor
36 Circular surface
38 Power source power connection
40 Consuming power connection
41 Material for increasing the thermal conductivity/resin material
42 Wiper arm
44 Wiper blade
46 Nozzle
48 Wiper lip
50 Wiper blade heating device
52 Reservoir
54 Power source

1. Connecting device for a windshield wiper system, having a one-piece housing made of a plastic material, the housing having at least one inlet connection for inflow of fluid and at least one outlet connection for the outflow of the fluid, and the inlet connection being connected in a fluid-conducting manner to the outlet connection via at least one fluid line provided in the housing, wherein the connecting device also has at least one valve for interrupting the fluid-conducting connection, at least one electric heating means which is provided for heating the fluid line and the valve, at least one power source power connection, and at least one consuming power connection,
the power source power connection being connectable to a power source, and the consuming power connection being connectable to an electrical consumer,
the electric heating means being supplied with power from the power source which is connected to the power source power connection, and
the consumer which is connected to the consuming power connection being supplied with power from the power source which is connected to the power source power connection.

2. Connecting device according to claim 1, wherein the valve is designed in the form of a check valve.

3. Connecting device according to claim 1, wherein the heating means is designed in the form of a PTC element.

4. Connecting device according to claim 1, wherein the PTC element has at least one resistor which has the shape of a circular disk.

5. Connecting device according to claim 4, wherein a circular surface of a resistor faces a section of the fluid line.

6. Connecting device according to claim 4, wherein a circular surface of the resistor faces the valve.

7. Connecting device according to claim 1, wherein a material for increasing the thermal conduction between the heating means and at least one section of the fluid line is provided.

8. Connecting device according to claim 1, wherein a material for increasing the thermal conduction between the heating means and the valve is provided.

9. Connecting device according to claim 7, wherein the material is a resin material.

10. Connecting device according to claim 1, wherein the housing is an injection-molded part.

11. Connecting device according to claim 1, wherein one inlet connection and two outlet connections are provided, the valve for interrupting the fluid-conducting connection being provided between the inlet connection and each of the outlet connections.

12. Connecting device according to claim 1, wherein a first and a second inlet connection as well as a first pair of outlet connections and a second pair of outlet connections are provided,
the first inlet connection being connected in a fluid-conducting manner to each of the outlet connections of the first pair via at least one first fluid line,
the second inlet connection being connected in a fluid-conducting manner to each of the outlet connections of the second pair via at least one second fluid line,
the second fluid line being separate from the first fluid line, and
a first valve for interrupting the fluid-conducting connection being provided between the first inlet connection and each of the outlet connections of the first pair, and
a second valve for interrupting the fluid-conducting connection being provided between the second inlet connection and each of the outlet connections of the second pair.

13. Connecting device according to claim 12, wherein one power source power connection and two consuming power connections, or two power source power connections and four consuming power connections are provided.

14. Connecting device according to claim 2, wherein the heating means is designed in the form of a PTC element.

15. Connecting device according to claim 2, wherein the PTC element has at least one resistor which has the shape of a circular disk.

16. Connecting device according to claim 3, wherein the PTC element has at least one resistor which has the shape of a circular disk.

17. Connecting device according to claim 5, wherein a circular surface of the resistor faces the valve.

18. Connecting device according to claim 2, wherein a material for increasing the thermal conduction between the heating means and at least one section of the fluid line is provided.

19. Connecting device according to claim 3, wherein a material for increasing the thermal conduction between the heating means and at least one section of the fluid line is provided.

20. Connecting device according to claim 4, wherein a material for increasing the thermal conduction between the heating means and at least one section of the fluid line is provided.
